(19) United States
(12) Patent Application Publication
(10) Pub. No.: US 2021/0250423 A1
(43) Pub. Date: Aug. 12, 2021

(54) SYSTEMS AND METHODS FOR PROVIDING A COMPANION MODE FOR APPLICATIONS AND MOBILE COMPUTING DEVICES

(71) Applicant: Labware Holdings, Inc., Wilmington, DE (US)

(72) Inventors: Vance V. Kershner, Wilmington, DE (US); Jon F. Raiford, Newark, DE (US)

(73) Assignee: Labware Holdings, Inc., Wilmington, DE (US)

(21) Appl. No.: 17/000,208

(22) Filed: Aug. 21, 2020

Related U.S. Application Data
(60) Provisional application No. 62/975,327, filed on Feb. 12, 2020.

(51) Int. Cl. H04L 29/08; G06F 9/44

(52) U.S. Cl. CPC H04L 67/327; G06F 9/44; H04L 67/24; H04L 67/141

(57) ABSTRACT

A system for providing a companion mode for an application is provided. The system records network information about a computing device used to access or execute the application and a mobile device associated with a user. When the user indicates through the application that they want to have the mobile device perform an action, the system uses the network information to provide code for the particular action to the mobile device. A mobile application stored on the mobile device may then perform the action using the code without the user taking any additional steps. The system may similarly allow the user of the mobile application to have the application of the computing device perform an action. The system may use the network information to create a persistent tunnel between the mobile application and the application through which the applications may communicate results of actions and requests to perform additional actions.

### BACKGROUND

Users of personal computing devices such as laptop or desktop computing devices may desire to incorporate data received from a mobile computing device into their workflow. For example, a user of a photograph editing application may desire to take a photograph on their mobile computing device and edit the photograph using their desktop computing device. In another example, a user of a laboratory management application may desire to scan a barcode on a sample using their mobile computing device, and to view or enter information about the scanned sample using their laptop computing device. In another example, a user of a word processing application may desire to dictate into the microphone of their mobile computing device, and to review and edit text corresponding to the dictation on their desktop computing device.

Currently, there are issues with respect to incorporating data received from a mobile computing device into a workflow associated with a desktop or laptop computing device. When a user desires to receive data from their mobile phone on their laptop or desktop computing device, the user must first manually transfer the data to the desktop or laptop computer. Typically, this is done by either physically tethering the mobile computing device to the laptop or desktop computing device, or by using a networking application such as email or SMS. Once the data is transferred, the user must then manually import the transferred data into the desired application on their laptop or desktop computing device. This creates a burden on the user.

### SUMMARY

A system for providing a companion mode for an application is provided. The system records network information about a computing device (e.g., laptop or desktop computer) used to access or execute the application and a mobile computing device (e.g., smartphone or tablet) associated with a user. The network information may include IP addresses, ports, MAC addresses, or IMEI numbers. When the user indicates through the application that they would like to have the mobile computing device perform a particular action, the system uses the network information associated with the user to provide code associated with the particular action to the mobile computing device. The mobile computing device may then perform the action using the code without the user taking any additional steps. In addition, the system may use the network information to create a tunnel between the mobile computing device and the application through which the mobile computing device may communicate any results of performing the action to the application.

In an embodiment, a method is provided. The method includes: receiving a request from an application by a computing device, wherein the request is for a mobile computing device to perform an action for the application and the application is associated with a user; in response to the request, retrieving first network information associated with the mobile computing device based on a user identifier associated with the user by the computing device; and providing an instruction to perform the action to the mobile computing device using the first network information by the computing device.

Embodiments may include some or all of the following features. The method may further include: receiving a result of performing the action from the mobile computing device; in response to receiving the result, retrieving second network information associated with the application based on the user identifier associated with the user; and providing the result to the application using the second network information. The application may be a web application. The action may include one or more of scanning a barcode, taking a photo, recording sound, and generating GPS coordinates. Providing the instruction to perform the action may include providing code that when executed by the mobile computing device causes the mobile computing device to perform the action. The method may further include creating a tunnel between the mobile computing device and the application using the first network information and second network information associated with the application, and a result of performing the action may be received by the application from the mobile computing device through the tunnel. The method may further include: receiving first login information from the mobile computing device, wherein the first login information includes the user identifier associated with the user and an identifier of the mobile computing device; based in part on the first login information, generating the first network information; and storing the first network information with the user identifier. The method may further include: receiving second login information from the application, wherein the second login information includes the user identifier associated with the user and an identifier of the application; based in part on the second login information, generating second network information; and storing the second network information with the user identifier.

In an embodiment, a method is provided. The method includes: receiving an instruction to perform an action for an application at a mobile computing device, wherein the instruction is received from a server; in response to the instruction, executing code corresponding to the action by the mobile computing device; and providing a result of executing the code corresponding to the action by the mobile computing device.

Embodiments may include some or all of the following features. Receiving the instruction to perform the action may include receiving the code corresponding to the action. The action may include one or more of scanning a barcode, taking a photo, recording sound, and generating GPS coordinates. The result may be provided to the server. The result may be provided to the application. The result may be provided via a tunnel between the mobile computing device and the application.

In an embodiment, a system is provided. The system may include at least one processor; and a non-transitory computer readable medium comprising instructions that, when executed by the at least one processor, cause the system to: receive a request from an application, wherein the request is for a mobile computing device to perform an action for the application and the application is associated with a user; in response to the request, retrieve first network information associated with the mobile computing device based on a user identifier associated with the user; and provide an instruction to perform the action to the mobile computing device using the first network information.

Embodiments may include some or all of the following features. The system may further: receive a result of performing the action from the mobile computing device; in response to receiving the result, retrieve second network information associated with the application based on the user identifier associated with the user; and provide the result to the application using the second network information. The application is a web application. The action may include one or more of scanning a barcode, taking a photo, recording sound, and generating GPS coordinates. Providing the instruction to perform the action may include providing code that when executed by the mobile computing device causes the mobile computing device to perform the action. The system may further create a tunnel between the mobile computing device and the application using the first network information and second network information associated with the application, wherein a result of performing the action is received by the application from the mobile computing device through the tunnel.

In an embodiment a method is provided. The method includes: receiving an instruction to perform an action for a mobile application at a computing device, wherein the instruction is received from a server; in response to the instruction, executing code corresponding to the action by the computing device; and providing a result of executing the code corresponding to the action by the computing device.

Embodiments may include some or all of the following features. Receiving the instruction to perform the action may include receiving the code corresponding to the action. The action may include one or more of sounding an alarm, printing a document, or operating a peripheral device associated with the computing device. Providing the result may include providing the result to the server. Providing the result may include providing the result to the mobile application. Providing the result may include providing the result via a tunnel between the mobile application and the computing device.

In an embodiment, a system is provided. The system includes: at least one processor; and a non-transitory computer readable medium comprising instructions that, when executed by the at least one processor, cause the system to: receive a request from a mobile application, wherein the request is for a computing device to perform an action for the mobile application and the mobile application is associated with a user; in response to the request, retrieve first network information associated with the computing device based on a user identifier associated with the user; and provide an instruction to perform the action to the computing device using the first network information.

Embodiments may include some or all of the following features. The system may: receive a result of performing the action from the computing device; in response to receiving the result, retrieve second network information associated with the mobile application based on the user identifier associated with the user; and provide the result to the mobile application using the second network information. The action may include one or more of sounding an alarm, printing a document, or operating a peripheral device associated with the computing device. Providing the instruction to perform the action may include providing code that when executed by the computing device causes the computing device to perform the action. The system may: create a tunnel between the computing device and the mobile application using the first network information and second network information associated with the mobile application, a result of performing the action may be received by the mobile application from the computing device through the tunnel.

The companion system described herein provides many advantages over the prior art. First, because the companion system collects and records network information about both the application and the mobile computing device associated with the user, data and results can be easily exchanged even where the computing device used to execute or access the application and the mobile computing device are on different networks. Second, because the companion system provides action-specific code directly to the mobile computing device that causes the mobile computing device to perform the action and provide any results directly to the application, significant time is saved by the user when compared to prior techniques.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 is an illustration of an example environment for operating a mobile computing device in companion mode;

FIG. 2 is an illustration of an example method for implementing a companion mode with respect to an application and a mobile computing device;

FIG. 3 is an illustration of an example method for implementing a companion mode with respect to an application and a mobile computing device;

FIG. 4 is an illustration of an example method for implementing a companion mode with respect to an application and a mobile computing device; and

FIG. 5 illustrates an example computing device.

### DETAILED DESCRIPTION

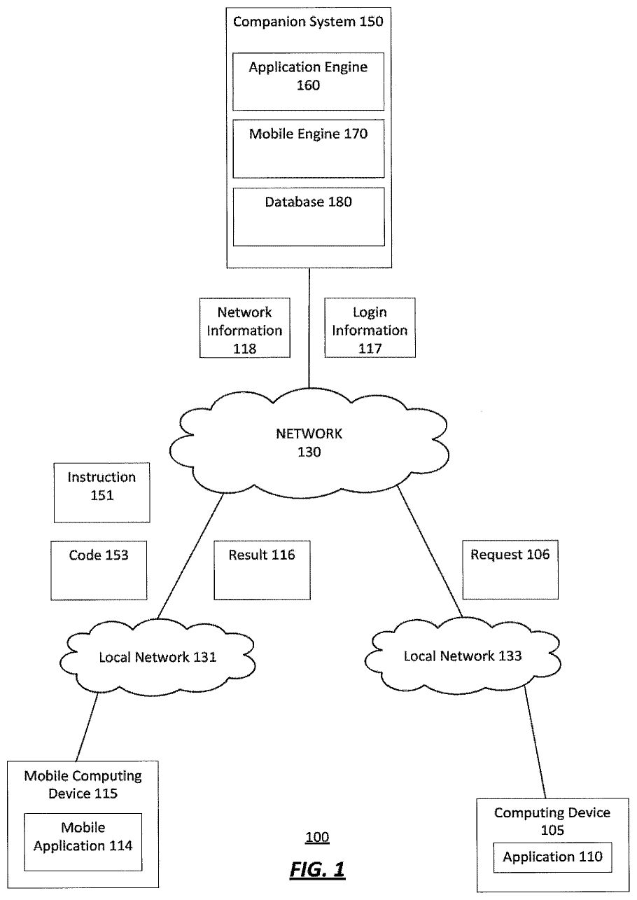

FIG. 1 is an illustration of an example environment 100 for operating a mobile computing device 115 in companion mode. As shown, the environment 100 includes a companion system 150 that provides a companion mode to an application 110 running on a computing device 105 and a corresponding mobile application 114 running on the mobile computing device 115. The application 110 may be a variety of application types such as a laboratory management application, an image editing application, or a word processing application. Other types of applications may be supported.

The mobile application 114 may be an “app” or other type of mobile application that is downloaded (or side loaded) onto the mobile application 114 from an app store or other application repository. During the companion mode, the application 110 may control the mobile computing device 115 (via the mobile application 114) and may receive data from the mobile computing device 115. In addition, during the companion mode, the mobile application 114 may control the computing device 110 (via the application 110) and may receive data from the computing device 105 The mobile application 114 may also control peripheral devices associated with the application 110 and/or computing device 105 such as printers, scanners, speakers, web cams, etc.

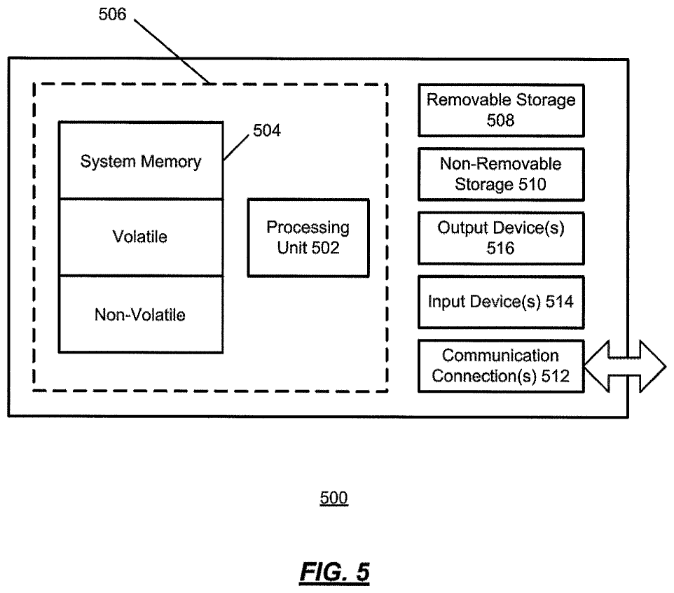

The application 110 may be executed by a computing device 105 such as a laptop or desktop computing device. Alternatively, the application 110 may be a web-based application that may be executed on a remote server or cloud-based computing device. The user may then access and control the application 110 using a browser executed on the computing device 105. An example of a suitable computing device 105 is the computing device 500 illustrated with respect to FIG. 5.

The mobile computing device 110 may include a variety of computing devices such as smartphones, tablets, laptops, video game consoles, augmented reality headsets, virtual reality headsets, and set top boxes. Other types of computing devices may be used. Note that while it is contemplated that in many embodiments the mobile computing device 115 is mobile (i.e., can be easily moved to another location), in some embodiments the mobile computing device 115 may be implemented using a less-mobile computing device such as a desktop computing device. An example of a suitable mobile computing device 115 is the computing device 500 illustrated with respect to FIG. 5.

The mobile computing device 115, computing device 105, and the companion system 150 may communicate through the network 130. The network 130 may be a combination of variety of network types including, but not limited to, a packet switched network (i.e., the internet), a cellular network, and a local area network. Any type of network or networking technology may be used.

The mobile computing device 115 and the computing device 105 may connect to the network 130 through a local network 131 and a local network 133, respectively. The local network 131 may be a network associated with the mobile computing device 115 and may include cellular networks, Wi-Fi networks, ethernet networks, etc. The local network 133 may be a network associated with the computing device 105 and may include cellular networks, Wi-Fi networks, ethernet networks, etc. The local network 131 and the local network 133 may be different networks or may be the same network. The local networks 131 and 133 may be part of the network 130, for example.

The companion system 150 may include an application engine 160, a mobile engine 170, and a database 180. More or fewer components may be supported. Each component of the companion system 150 may be implemented using a same or different computing device such as the computing device 500 of FIG. 5.

The application engine 160 may provide services related to the application 110. Initially, when a user of the application 110 desires to use the application 110 in the companion mode, the user of the application 110 may cause the application 110 to provide login information 117 to the application engine 160. The login information 117 may include information such as a user identifier that uniquely identifies the user of the application 110 to the application engine 160 and a password.

The application engine 160 may authenticate the user using the login information 117 and may generate what is referred to herein as network information 118 associated with the user and application 110. Depending on the embodiment, the network information 118 may include information that may be used by the application engine 160 to connect with the application 110 and/or computing device 105 via the network 130. The network information 118 may include information such as an IP address, network ports, MAC addresses, tokens, passwords, and any other information that may be used to connect to an application 110 and/or computing device 105 through the network 130 (and the local network 133).

The application engine 160 may store the generated network information 118 for the application 110 along with the user identifier provided in the login information 117. The application engine 160 may store the network information 118 in the database 180 such that the network information 118 can be later retrieved from the database 180 using the user identifier.

The mobile engine 170 may provide services related to the application 110 to the mobile computing device 115 via the mobile application 114 and may facilitate the companion mode where the user of the application 110 is able to communicate with and control the mobile computing device 110 through the application 110.

After the user logs into the application engine 160, the user may similarly use the mobile application 114 to provide login information 117 to the mobile engine 170. The login information 117 may include the same user identifier and/or password as provided by the application 110 to the application engine 160.

The mobile engine 170 may authenticate the user using the login information 117 and may generate network information 118 associated with the user and the mobile computing device 115. Depending on the embodiment, the network information 118 may include information that may be used by the mobile engine 170 to connect with the mobile application 114 of the mobile computing device 115 via the network 130. The network information 118 may include information such as an IP address, telephone number, network ports, MAC addresses, tokens, passwords, IMEI numbers, and any other information that may be used to connect to the mobile application 114 of the mobile computing device 115 through the network 130 (and the local network 131).

The mobile engine 170 may store the generated network information 118 for the mobile computing device 115 along with the user identifier provided in the login information 117. The mobile engine 160 may store the network information 118 in the database 180 such that the network information 118 can be later retrieved from the database 180 using the user identifier.

After providing the login information 117 for both of the application 110 and mobile application 114 of the mobile computing device 115, the user of the application 110 may begin using the mobile computing device 115 in companion mode along with the application 110.

To begin companion mode, a user of the application 110 may select an option to have the mobile computing device 115 perform an action on behalf of the application 110. The action may depend on the type of application 110 and may include actions such as scan a barcode, take a picture, scan a fingerprint, scan a face, record a sound, take a video, retrieve GPS coordinates, etc. In general, each action may relate to the use of one or more sensors of the mobile computing device 115 such as a camera, accelerometer, microphone, gyroscope, magnetometer, GPS, proximity sensor, ambient light sensor, touchscreen sensor, fingerprint sensor, pedometer, barcode sensor, barometer, heart rate sensor, thermometer, air humidity sensor, and Geiger counter. Other sensors may be supported.

Note that the sensors may include sensors that are part of the mobile computing device 115 (i.e., camera and accelerometer) as well as external sensors that have been connected to the mobile computing device 115 through a port or wireless interface. For example, the mobile computing device 115 may be attached to pH meter through a port allowing it to take pH measurements. In another example, the mobile computing device 115 may be wirelessly attached to an IR camera via Bluetooth allowing it to capture IR images from the IR camera.

Depending on the embodiment, the user may select an action for the mobile computing device 115 to perform from a list of actions that are supported by the application 110. The list of actions may be contextual and may be based on the type of data being entered or viewed by the user of the application 110.

For example, the user may be using the application 110 to record data about a particular sample and may be presented with a text box through which the user may enter a sample number corresponding to the sample. When the user indicates that they would like to use companion mode to enter the sample number, the application 110 may present the user with an option to initiate a barcode scan using their mobile computing device 110. Later, the user may be presented with a text box through which the user may enter a temperature for the sample. When the user indicates that they would like to use companion mode to enter the temperature, the application 110 may present the user with an option to initiate a temperature measurement using their mobile computing device 110.

After the user of the application 110 determines to perform an action using the mobile computing device 115, the application 110 may generate a request 106, and may provide the request 106 to the application engine 160 through the network 130. The request 106 may include an identifier of the action (or actions) that the user desires to have performed by the mobile computing device 115 and the user identifier. Other information may be included in the request 106.

The application engine 160 may receive the request 106 and may use the user identifier associated with the request 106 to locate the network information 118 associated with the mobile computing device 115 in the database 180. As described above, the database 180 may include network information 118 for both the mobile computing device 115 and the application 110 indexed by the user identifier.

The mobile engine 170 may generate an instruction 151 for the mobile application 114 of the mobile computing device 110 based on the received request 106. The instruction 151 may be an instruction to perform the particular action selected by the user of the application 110.

Depending on the embodiment, the instruction 151 may further include code 153 corresponding to the particular action. The code 153 when executed by the mobile application 114 of the mobile computing device 115 may cause the mobile computing device 115 to perform the particular action. Alternatively, the code 153 for the action may already be stored on the mobile computing device 115, or may be available at another location.

The mobile engine 170 may provide the instruction 151 to the mobile application 114 of the mobile computing device 115 through the network 130 (and the local network 131). The mobile engine 170 may provide the instruction 151 according to the network information 118 associated with the mobile application 114 and the mobile computing device 115. Where the instruction 151 includes the code 153, upon receipt of the instruction 151, the mobile application 114 of the mobile computing device 115 may begin executing the code 153 without any further action taken by the user. Alternatively, the mobile application 114 may prompt the user to confirm that they want to execute the code 153.

Where the instruction 151 does not include the code 153, the mobile application 114 may retrieve the code 153 referenced in the instruction 151 (either from memory or another network source) and may begin executing the code 153.

In some embodiments, after executing the code 153, the mobile application 114 may generate a result 116. The result 116 may depend on the particular action that was performed using the code 153. Where the action was scanning a barcode, the result 116 may be a number encoded into the barcode. Where the action was to take a picture, the result 116 may be an image.

In some embodiments, the mobile computing device 115 may provide the result 116 to the mobile engine 170 through the network 130 via the local network 131. The application engine 160 may then return the result 116 to the application 110 in response to the request 106. The application 110 may then display the result 116 to the user or may otherwise incorporate the result 116. Continuing the barcode example, the application 110 may display the sample number from the barcode returned in the result 116 into the text box.

In some embodiments, rather than have the mobile computing device 115 return the result 116 to the companion system 150, the mobile computing device 115 and/or the mobile application 114 may directly communicate the result 116 to the application 110 through the network 130. In one embodiment, the mobile engine 170 may include the network information 118 associated with the application 110 in the instruction 151. The mobile computing device 115 or mobile application 114 may then provide the result 116 directly to the application 110 using the network information 118.

In another embodiment, after providing the instruction 151 to the mobile communication device 115, the mobile engine 170 may use the network information 118 associated with the mobile computing device 115 and the network information 118 associated with the application 110 to create a network tunnel between the mobile computing device 115 and the application 110. After creating the tunnel, the mobile computing device 115 and the application 110 may communicate directly through the tunnel. Any method for creating a network tunnel may be used. The tunnel may persist for the duration of the companion mode.

In some embodiments, the companion system 150, as part of the companion mode, may also allow a user to control the operation of the application 110 on the computing device 105 using the mobile application 114 of the mobile computing device 115. For example, the user of the mobile computing device 115 may desire to have an alarm sound on the computing device 110. The user may select an option to sound an alarm using the mobile computing device 115. In response, the mobile application 114 may send a request 106 to the mobile engine 170. The application engine 160 may generate an instruction 151 to sound the alarm that may include code 153 corresponding to the alarm. The application engine 160 may then send the instruction 151 to the application 110 using the network information 118 associated with the application 110 and computing device 105. The application 110 may then execute the code 153 to cause the alarm to sound.

As another example, the user of the mobile computing device 115 may want to control a peripheral device associated with the computing device 105 and/or the local network 133. The peripheral may include a printer and the user may desire to print a document such as one or more labels for a sample, for example. The user may select an option to print to the printer using the mobile computing device 115. In response, the mobile application 114 may send a request 106 to the mobile engine 170. The application engine 160 may generate an instruction 151 to print that may include code 153 corresponding to the particular document being printed. The application engine 160 may then send the instruction 151 to the application 110 using the network information 118 associated with the application 110 and computing device 105. The application 110 may then execute the code 153 to cause the document to print on the selected printer. Depending on the embodiment, the application 110 may push or publish a list of available peripheral devices to the companion system 150. The companion system 150 may then push the list to the mobile application 114 where it may be displayed to the user on the mobile computing device 115.

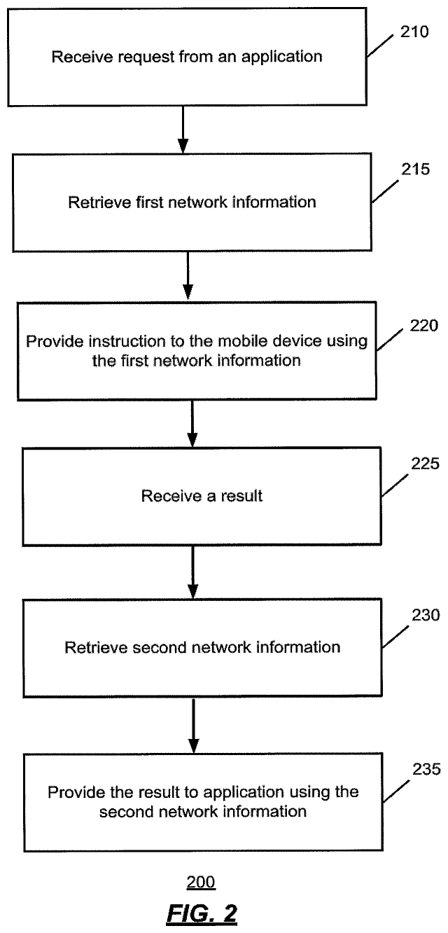

FIG. 2 is an illustration of an example method 200 for implementing a companion mode with respect to an application 110 and a mobile computing device 115. The method 200 may be implemented by the companion system 150.

At 210, a request is received from an application. The application 110 may be a laboratory management application. Other types of applications may be supported. The request 106 may be from a user of the application 110 and may be a request to perform an action using a mobile computing device 115 associated with the user. Depending on the embodiment, the request 106 may include login information 117 associated with the user such as a user identifier and/or a password.

At 215, first network information 118 is retrieved. The first network information 118 may be retrieved from the database 180 by the application engine 160 using the user identifier associated with the request 106. The first network information 118 may include information needed to make a network connection with the mobile computing device 115 such as an IP address, an IMEI number, a port number, etc. Other information may be included. The first network information 118 may have been determined by the mobile engine 170 previously when the user connected or registered the mobile computing device 115 with the companion system 150.

At 220, an instruction is provided to the mobile computing device. The instruction 151 may be provided to the mobile computing device 115 by the mobile engine 170. Depending on the embodiment, the instruction 151 may be provided to a mobile application 114 executing on the mobile computing device 115. The instruction 151 may include code 153 that when executed by the mobile computing device 115 (or mobile application 114) will cause the mobile computing device 115 to perform the action indicated in the request 106. The code 153 may include JavaScript, BASIC, Smalltalk, and LIMS BASIC code. Other types of code may be supported.

At 225, a result of performing the action is received. The result 116 may be received by the mobile engine 170 from the mobile computing device 115 through the network 130.

At 230, second network information is retrieved. The second network information 118 may be retrieved from the database 180 using the user identifier associated with the result 116 and/or the request 106. The second network information 118 may be used to make a network connection with the application 110 and may include information such as IP address, port number, etc. Other information may be included.

At 235, the result is provided to the application using the second network information. The result 116 may be provided by the application engine 160 to the application 110. The result 116 may be displayed to the user in the application 110 and/or incorporated into a calculation or record.

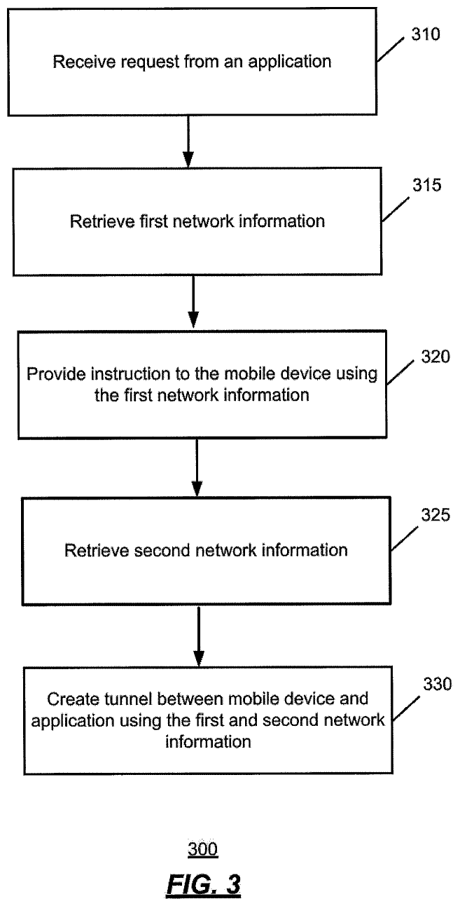

FIG. 3 is an illustration of an example method 300 for implementing a companion mode with respect to an application 110 and a mobile computing device 115. The method 300 may be implemented by the companion system 150.

At 310, a request is received from an application. The application 110 may be a laboratory management application. Other types of applications may be supported. The request 106 may be from a user of the application 110 and may be a request to perform an action using a mobile computing device 115 associated with the user. Depending on the embodiment, the request 106 may include login information 117 associated with the user such as a user identifier and/or a password.

At 315, first network information 118 is retrieved. The first network information 118 may be retrieved from the database 180 by the application engine 160 using the user identifier associated with the request 106. The first network information 118 may include information needed to make a network connection with the mobile computing device 115 and a mobile application 114 running on the mobile computing device 115.

At 320, an instruction is provided to the mobile computing device. The instruction 151 may be provided to the mobile computing device 115 by the mobile engine 170. The instruction 151 may include code 153 that when executed by the mobile computing device 115 and/or the mobile application 114 will cause the mobile computing device 115 to perform the action indicated in the request 106.

At 325, second network information is retrieved. The second network information 118 may be retrieved by the mobile engine 170 from the database 180. The second network information 118 may include information needed to make a network connection with the application 110.

At 330, a tunnel is created between the mobile computing device and the application using the first and second network information. The tunnel may be a network tunnel and may be created by the application engine 160 and or the mobile engine 170. Depending on the embodiment, the mobile computing device 115 may use the tunnel to provide a result 116 generated from executing the code 153 associated with the request 106. The network tunnel may persist for the duration of the companion mode.

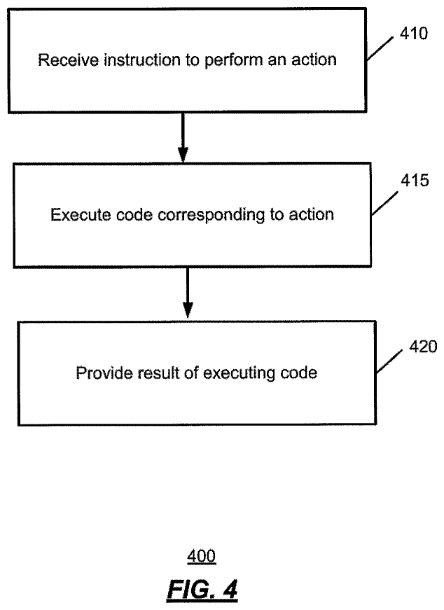

FIG. 4 is an illustration of an example method 400 for implementing a companion mode with respect to an application 110 and a mobile computing device 115. The method 400 may be implemented by the companion system 150.

At 410, an instruction to perform an action is received. The instruction 151 may be received by the mobile computing device 115 and/or a mobile application 114 from the mobile engine 170. The instruction 151 may be to perform an action on behalf of the application 110. The instruction 151 may include executable code 153 corresponding to the action or may include a reference to the executable code 153.

At 415, code corresponding to the action is executed. The code 153 may be executed in response to the mobile computing device 115 receiving the instruction 151. Depending on the embodiment, the code 153 may be executed without any action being taken by the user. Alternatively, the mobile computing device 115 and/or mobile application 114 may prompt the user to confirm that they would like to execute the code 153.

At 420, a result of executing the code is provided. The result 116 of executing the code 153 may be provided by the mobile computing device 115. Depending on the embodiment, the mobile computing device 115 may provide the result 116 to the mobile engine 170 or may provide the result 116 directly to the application using a network tunnel.

FIG. 5 shows an exemplary computing environment in which example embodiments and aspects may be implemented. The computing system environment is only one example of a suitable computing environment and is not intended to suggest any limitation as to the scope of use or functionality.

Numerous other general purpose or special purpose computing system environments or configurations may be used. Examples of well-known computing systems, environments, and/or configurations that may be suitable for use include, but are not limited to, personal computers, servers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 5, an exemplary system for implementing aspects described herein includes a computing device, such as computing device 500. In its most basic configuration, computing device 500 typically includes at least one processing unit 502 and memory 504. Depending on the exact configuration and type of computing device, memory 504 may be volatile (such as random access memory (RAM)), non-volatile (such as read-only memory (ROM), flash memory, etc.), or some combination of the two. This most basic configuration is illustrated in FIG. 5 by dashed line 506.

Computing device 500 may have additional features/functionality. For example, computing device 500 may include additional storage (removable and/or non-removable) including, but not limited to, magnetic or optical disks or tape. Such additional storage is illustrated in FIG. 5 by removable storage 508 and non-removable storage 510.

Computing device 500 typically includes a variety of tangible computer readable media. Computer readable media can be any available tangible media that can be accessed by device 500 and includes both volatile and non-volatile media, removable and non-removable media.

Tangible computer storage media include volatile and non-volatile, and removable and non-removable media implemented in any method or technology for storage of information such as computer readable instructions, data structures, program modules or other data. Memory 504, removable storage 508, and non-removable storage 510 are all examples of computer storage media. Tangible computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer storage media may be part of computing device 500.

Computing device 500 may contain communications connection(s) 512 that allow the device to communicate with other devices. Computing device 500 may also have input device(s) 514 such as a keyboard, mouse, pen, voice input device, touch input device, etc. Output device(s) 516 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Aspect of the invention include the following.

Aspect 1 is a method comprising: receiving a request from an application by a computing device, wherein the request is for a mobile computing device to perform an action for the application and the application is associated with a user; in response to the request, retrieving first network information associated with the mobile computing device based on a user identifier associated with the user by the computing device; and providing an instruction to perform the action to the mobile computing device using the first network information by the computing device.

The method of aspect 1 may further comprise: receiving a result of performing the action from the mobile computing device; in response to receiving the result, retrieving second network information associated with the application based on the user identifier associated with the user; and providing the result to the application using the second network information.

In the method of aspect 1, the application can be a web application. The action can comprise one or more of scanning a barcode, taking a photo, recording sound, and generating GPS coordinates. The step of providing the instruction to perform the action can include providing code that when executed by the mobile computing device causes the mobile computing device to perform the action.

The method of aspect 1 can further comprise: creating a tunnel between the mobile computing device and the application using the first network information and second network information associated with the application, wherein a result of performing the action is received by the application from the mobile computing device through the tunnel.

The method of aspect 1 can also further comprise: receiving first login information from the mobile computing device, wherein the first login information includes the user identifier associated with the user and an identifier of the mobile computing device; based in part on the first login information, generating the first network information; and storing the first network information with the user identifier. This may further comprise: receiving second login information from the application, wherein the second login information includes the user identifier associated with the user and an identifier of the application; based in part on the second login information, generating second network information; and storing the second network information with the user identifier.

Aspect 2 is method comprising: receiving an instruction to perform an action for an application at a mobile computing device, wherein the instruction is received from a server; in response to the instruction, executing code corresponding to the action by the mobile computing device; and providing a result of executing the code corresponding to the action by the mobile computing device.

In aspect 2, receiving the instruction to perform the action can include receiving the code corresponding to the action. The action can comprise one or more of scanning a barcode, taking a photo, recording sound, and generating GPS coordinates.

In aspect 2, the result can be provided to the server, or it can be provided to the application, or the result is provided via a tunnel between the mobile computing device and the application.

Aspect 3 is a system comprising: at least one processor; and a non-transitory computer readable medium comprising instructions that, when executed by the at least one processor, cause the system to: receive a request from an application, wherein the request is for a mobile computing device to perform an action for the application and the application is associated with a user; in response to the request, retrieve first network information associated with the mobile computing device based on a user identifier associated with the user; and provide an instruction to perform the action to the mobile computing device using the first network information.

The system of aspect 3 can further comprise instructions that, when executed by the at least one processor, cause the system to: receive a result of performing the action from the mobile computing device; in response to receiving the result, retrieve second network information associated with the application based on the user identifier associated with the user; and provide the result to the application using the second network information.

In the system of aspect 3, the application can be a web application. The action can comprise one or more of scanning a barcode, taking a photo, recording sound, and generating GPS coordinates. The step of providing the instruction to perform the action can comprise providing code that when executed by the mobile computing device causes the mobile computing device to perform the action. This step can further comprise instructions that, when executed by the at least one processor, cause the system to create a tunnel between the mobile computing device and the application using the first network information and second network information associated with the application, wherein a result of performing the action is received by the application from the mobile computing device through the tunnel.

Aspect 4 is a system comprising: at least one processor; and a non-transitory computer readable medium comprising instructions that, when executed by the at least one processor, cause the system to: receive a request from a mobile application, wherein the request is for a computing device to perform an action for the mobile application and the mobile application is associated with a user; in response to the request, retrieve first network information associated with the computing device based on a user identifier associated with the user; and provide an instruction to perform the action to the computing device using the first network information.

The system of Aspect 4 can further comprise instructions that, when executed by the at least one processor, cause the system to: receive a result of performing the action from the computing device; in response to receiving the result, retrieve second network information associated with the mobile application based on the user identifier associated with the user; and provide the result to the mobile application using the second network information.

In the system of aspect 4, the action can comprise one or more of sounding an alarm, printing a document, or operating a peripheral device associated with the computing device. The step of providing the instruction to perform the action can include providing code that when executed by the computing device causes the computing device to perform the action.

The system of aspect 4 can further comprise instructions that, when executed by the at least one processor, cause the system to create a tunnel between the computing device and the mobile application using the first network information and second network information associated with the mobile application, wherein a result of performing the action is received by the mobile application from the computing device through the tunnel.

Aspect 5 is a method comprising: receiving an instruction to perform an action for a mobile application at a computing device, wherein the instruction is received from a server; in response to the instruction, executing code corresponding to the action by the computing device; and providing a result of executing the code corresponding to the action by the computing device.

In the method of aspect 5, receiving the instruction to perform the action comprises receiving the code corresponding to the action. The action comprises one or more of sounding an alarm, printing a document, or operating a peripheral device associated with the computing device. The step of providing the result comprises providing the result to the server, or providing the result to the mobile application, or providing the result via a tunnel between the mobile application and the computing device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method comprising:
receiving a request from an application by a computing device, wherein the request is for a mobile computing device to perform an action for the application and the application is associated with a user;
in response to the request, retrieving first network information associated with the mobile computing device based on a user identifier associated with the user by the computing device; and
providing an instruction to perform the action to the mobile computing device using the first network information by the computing device.

2. The method of claim 1, further comprising:
receiving a result of performing the action from the mobile computing device;
in response to receiving the result, retrieving second network information associated with the application based on the user identifier associated with the user; and
providing the result to the application using the second network information.

3. The method of claim 1, wherein the application is a web application.

4. The method of claim 1, wherein the action comprises one or more of scanning a barcode, taking a photo, recording sound, and generating GPS coordinates.

5. The method of claim 1, wherein providing the instruction to perform the action comprises providing code that when executed by the mobile computing device causes the mobile computing device to perform the action.

6. The method of claim 1, further comprising:
creating a tunnel between the mobile computing device and the application using the first network information and second network information associated with the application, wherein a result of performing the action is received by the application from the mobile computing device through the tunnel.

7. The method of claim 1, further comprising:
receiving first login information from the mobile computing device, wherein the first login information includes the user identifier associated with the user and an identifier of the mobile computing device;
based in part on the first login information, generating the first network information; and
storing the first network information with the user identifier.

8. The method of claim 7, further comprising:
receiving second login information from the application, wherein the second login information includes the user identifier associated with the user and an identifier of the application;
based in part on the second login information, generating second network information; and
storing the second network information with the user identifier.

9. A method comprising:
receiving an instruction to perform an action for an application at a mobile computing device, wherein the instruction is received from a server;
in response to the instruction, executing code corresponding to the action by the mobile computing device; and
providing a result of executing the code corresponding to the action by the mobile computing device.

10. The method of claim 9, wherein receiving the instruction to perform the action comprises receiving the code corresponding to the action.

11. The method of claim 9, wherein the action comprises one or more of scanning a barcode, taking a photo, recording sound, and generating GPS coordinates.

12. The method of claim 9, wherein the result is provided to the server.

13. The method of claim 9, wherein the result is provided to the application.

14. The method of claim 9, wherein the result is provided via a tunnel between the mobile computing device and the application.

15. A system comprising:
at least one processor; and
a non-transitory computer readable medium comprising instructions that, when executed by the at least one processor, cause the system to:
receive a request from an application, wherein the request is for a mobile computing device to perform an action for the application and the application is associated with a user;
in response to the request, retrieve first network information associated with the mobile computing device based on a user identifier associated with the user; and
provide an instruction to perform the action to the mobile computing device using the first network information.

16. The system of claim 15, further comprising instructions that, when executed by the at least one processor, cause the system to:
receive a result of performing the action from the mobile computing device;
in response to receiving the result, retrieve second network information associated with the application based on the user identifier associated with the user; and
provide the result to the application using the second network information.

17. The system of claim 15, wherein the application is a web application.

18. The system of claim 15, wherein the action comprises one or more of scanning a barcode, taking a photo, recording sound, and generating GPS coordinates.

19. The system of claim 15, wherein providing the instruction to perform the action comprises providing code that when executed by the mobile computing device causes the mobile computing device to perform the action.

20. The system of claim 15, further comprising instructions that, when executed by the at least one processor, cause the system to:
create a tunnel between the mobile computing device and the application using the first network information and second network information associated with the application, wherein a result of performing the action is received by the application from the mobile computing device through the tunnel.
